(19) United States
(12) Patent Application Publication
(10) Pub. No.: US 2014/0071290 A1
(43) Pub. Date: Mar. 13, 2014

(54) Tiered Storage for Video Surveillance

(71) Applicant: FUTUREWEI TECHNOLOGIES, INC., Plano, TX (US)

(72) Inventors: Stephen Collen, Boulder Creek, CA (US); Nalin Mistry, Ottawa (CA)

(73) Assignee: Futurewei Technologies, Inc., Plano, TX (US)

(21) Appl. No.: 13/760,735

(22) Filed: Feb. 6, 2013

Related U.S. Application Data
(60) Provisional application No. 61/700,227, filed on Sep. 12, 2012.

(51) Int. Cl. H04N 9/79

(52) U.S. Cl. CPC H04N 9/79
USPC 348/159; 348/207.1

(57) ABSTRACT

An apparatus comprising a processor configured to receive captured video, and perform a two-stage video content management protocol, wherein the first stage comprises classifying the video content according to one or more granular variables, and wherein the second stage comprises queuing classified video in a storage memory.

### CROSS-REFERENCE TO RELATED APPLICATIONS

This application claims priority to U.S. Provisional Application No. 61/700,227, filed Sep. 12, 2012 by Stephen Collen et al. titled “Tiered Storage and Policy Management for Video Surveillance,” which is incorporated herein by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Networking vendors historically focused on the “transport” component of the video surveillance solution. Specific transport elements of concern included: connectivity (local area network (LAN)/wide area network (WAN)), routing/forwarding, bandwidth, Internet Protocol (IP) Quality of Service (QoS), network security, and layer 2 (Institute of Electrical and Electronics Engineers (IEEE) 802.1q, IEEE 802.1p). Networking vendors may perform archiving in the camera using local storage and subsequently archive to off-board storage at pre-determined intervals. Alternately, vendors may archive in the back-end using data recording, e.g., a Network Video Recorder (NVR)/Digital Video Recorder (DVR), and storage component of the video surveillance solution. Such coarse archiving may be performed using a shared storage pool, i.e., content from multiple cameras stored in a shared pool independent of the camera type, e.g., simple to High Definition (HD). Such solutions, however, have proved insufficient in various regards.

### SUMMARY

In one aspect, the disclosure includes an apparatus comprising a processor configured to receive captured video, and perform a two-stage video content management protocol, wherein the first stage comprises classifying the video content according to one or more granular variables, and wherein the second stage comprises queuing classified video in a storage memory.

In another aspect, the disclosure includes a computer program product comprising computer executable instructions stored on a non-transitory medium that when executed by a processor cause the processor to monitor a performance metric associated with each of a plurality of storage locations, wherein each storage location has at least one memory pool, receive a video, wherein the video is classified according to at least one predefined criteria, utilize the video classification and the performance metrics to determine a destination storage location memory pool, and send the video to the destination storage location memory pool for storage.

In yet another aspect, the disclosure includes in a network node of a network system comprising a plurality of nodes, a method of managing video storage, comprising receiving a video from a video source, identifying the classification of the video content, monitoring a plurality of network performance parameters, selecting a destination network memory pool based on the classification of the video content and the results of the network performance parameter monitoring, transmitting the video to the destination network memory pool, obtaining the storage location of the video in the network memory pool, assigning a pointer to the storage location of the video, and adding the pointer to a pointer queue.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is an embodiment of a network backup system for adaptive backup or synchronization service in a network.

FIG. 2 is an embodiment of media flow from a camera to a storage location.

FIG. 3 is a flowchart describing a method of transferring archiving content.

FIG. 4 depicts several possible pathway configurations for a tiered storage and policy management for video surveillance embodiment.

FIG. 5 is a flowchart describing an embodiment of a method of tiered storage and policy management for video surveillance.

FIG. 6 depicts three example managed video surveillance content memory pools.

FIG. 7 is a schematic diagram of an embodiment of a video capture device.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In one aspect, this disclosure concerns video surveillance storage management with archiving performed at the customer premise, and/or the private, public, or hybrid public/private cloud. The proposed process may include two stages: classification and queuing. Classification may include granular identification of the video content. Queuing of content in the local storage, network and/or cloud may refer to creating queues containing pointers to where media is stored in a memory pool based on the results of the classification stage. The memory pools may be shared or dedicated, and may further be public or private. Benefits of the disclosure may include granularity of content archiving, content traffic and congestion management, policy based archiving to multiple destinations, and video storage & archiving support in network device(s).

In another aspect, this disclosure concerns traffic and congestion management support of archive-routed surveillance videos, which may occur at the queue and memory pool level based on size, thresholds, and action, in manners accessible to one having ordinary skill in the relevant art. Video surveillance content may further be archived to multiple storage endpoints based on policy-based video management. Policy management defines policies for situational-based routing of archive video surveillance content to one of multiple targets (e.g., network, public, or private memory pools and/or storage locations). Policies may include various treatment services to be applied as part of archiving, for example, content encryption, content compression, and high availability/reliability when routing critical data. Video storage & archiving support may occur at the customer premises, e.g., router, switch and/or access point.

Certain disclosed approaches are software implementable, which may provide benefits such as ease of implementation on existing network and IT elements, as well as the flexible form factor and placement in the network.

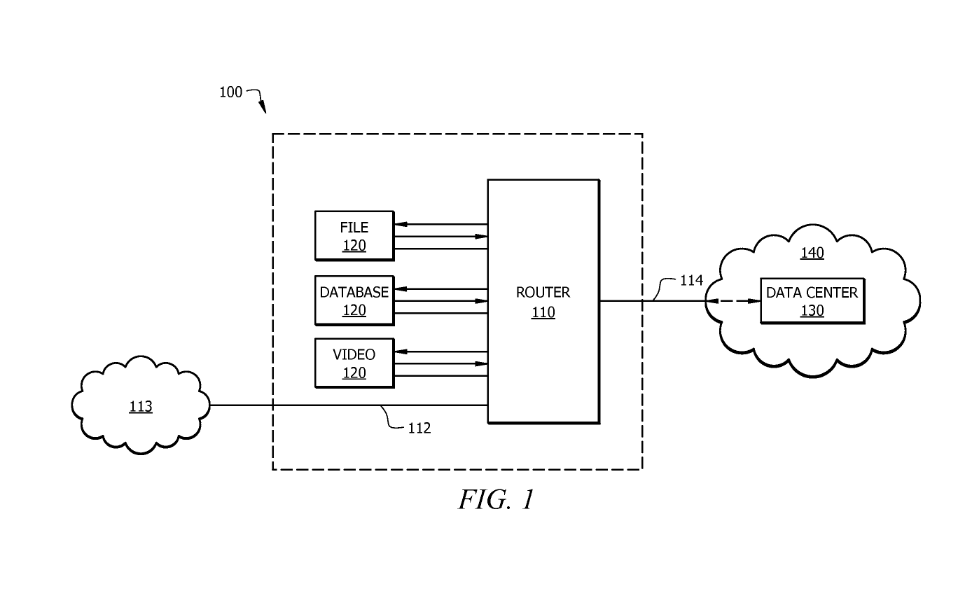

FIG. 1 is an embodiment of a network backup system 100 that may be used to provide at least some of the tiered storage and policy management services in a network. The network backup system 100 may comprise a router 110 which may be coupled via a first link 112, e.g., a wired or wireless LAN or WAN, to a network or domain 113, and via a second link 114, e.g., a wired or wireless LAN or WAN, to a data center 130, which may reside in a WAN 140. In one embodiment, the first link 112 may be a wireless LAN (WLAN) link and the second link 114 may be a wired WAN link. The router 110 may be coupled to a WLAN via a first link 112 and to a WAN 140 via the second link 114. The router 110 may also be coupled to one or more backup data systems 120 via links as shown. The backup data systems 120 may optionally be integral to or separate from router 110. The links discussed herein may be any type of optical or electrical network link for transporting data signals. In FIG. 1, one backup system 120 is illustrated as a file backup service, one backup data system 120 is illustrated as a database (DB) backup service, and one backup data system 120 is illustrated as a video backup service. These services are used for illustrative purposes and other backup services are possible and may optionally or alternatively be included or otherwise employed. In other embodiments, the network backup system 100 may comprise a plurality of routers 110 that may be configured similarly and coupled to one or more WLANs, LANs, WANs, and backup data systems 120. The network(s) may be an IP network or any other type of network.

The router 110 may be an edge node of the network, such as an edge or access router, a gateway, or a customer edge device that may be configured to forward traffic between a first link 112 (e.g., a LAN link) and a second link 114 (e.g., a WAN link). The backup data systems 120 may comprise storage units or devices that store data forwarded from the router 110, send stored data to the router 110, or both. The backup data systems 120 may be located in one or more remote locations from a network core (e.g., a WAN), such as in one or more data centers or at a local office with the router 110. The router 110 may forward data from traffic received on a second link 114 (e.g., a WAN link) to the backup data systems 120, and send stored data from the backup data systems 120 on the second link 114 to a data center 130 for backup. The data center 130 may reside in a WAN.

The router 110 may comprise one or more service appliances and/or service cards that may control corresponding backup and synchronization services. The services may generate relatively high volume and low priority traffic, which may be exchanged via the second link 114 and/or the first link 112 (e.g., LAN links). The backup data may have lower priority in comparison to the normal traffic (e.g., real-time or web based traffic). Examples of the lower priority data include backup data for video surveillance services, database services, file systems, and other types of services where data is stored remotely and subsequently retrieved. The router 110 may receive lower priority data from WAN 140 on the second link 114 and forward the data to the backup data systems 120. To retrieve the backup data, the router 110 may send the stored data from the backup data systems 120 on the second link 114 to the WAN 140 when the data is needed, in the case of data loss, or in the case of network failure. Alternately, the stored data may be sent back to the network to synchronize the data that may be stored in a local office (e.g., associated with a LAN) with data stored at data center 130.

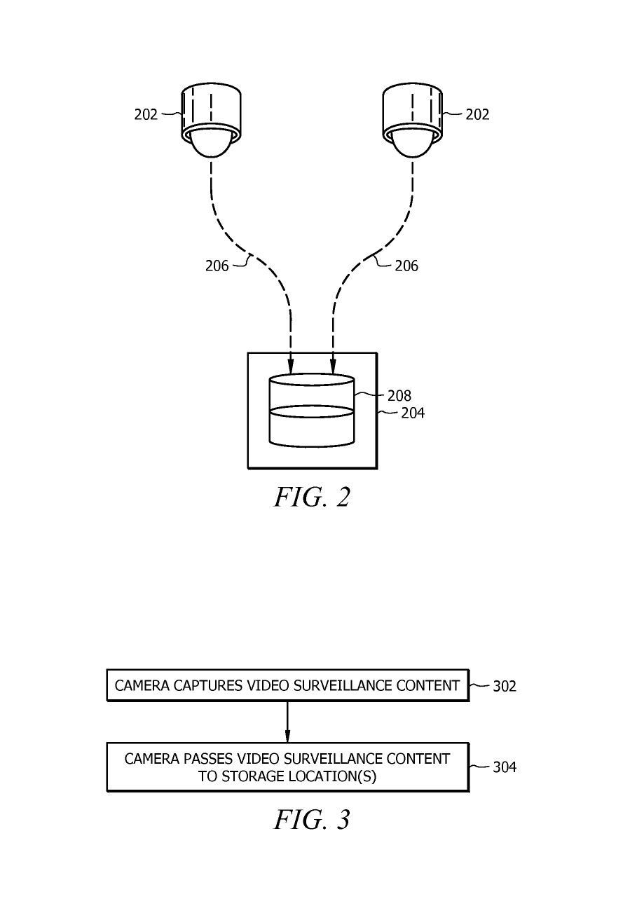

FIG. 2 is an embodiment of media flow from a camera 202, e.g., a video surveillance camera or the camera of a mobile communication device, e.g., a smartphone, to a storage location 204, e.g., a DVR/digital video server (DVS). In alternate embodiments, camera 202 may be comprised within a network backup system, e.g., the network backup system 100 of FIG. 1. In FIG. 2, media, e.g., surveillance video content from cameras 202, may be transmitted via connection paths 206, e.g., link 112 of FIG. 1, into a shared memory pool 208 at the storage location 204. A memory pool may be defined as storage media, e.g., a dynamically allocated memory location on a computer hard drive or a group of variable-size allocations or regions. Storage location 204, e.g., a backup data system 120 of FIG. 1, may be located at a local facility, e.g., on a business or academic campus, or remotely, e.g., at a data center or a network cloud. Media may stream from the cameras 202 to the storage location 204 for archiving purposes. Current art media streams do not provide a system or method for granular archiving of video surveillance media.

FIG. 3 is a flowchart describing a method 300 of transferring archiving content. At block 302, one or more cameras, e.g., cameras 202 of FIG. 2, may capture surveillance video content. At block 304, the camera may pass video content to one or more storage locations, e.g., the storage location 204 of FIG. 2, an intelligent NVR storage service, a network storage device, a cloud service, etc., via a communications link, e.g., a link 206 of FIG. 2.

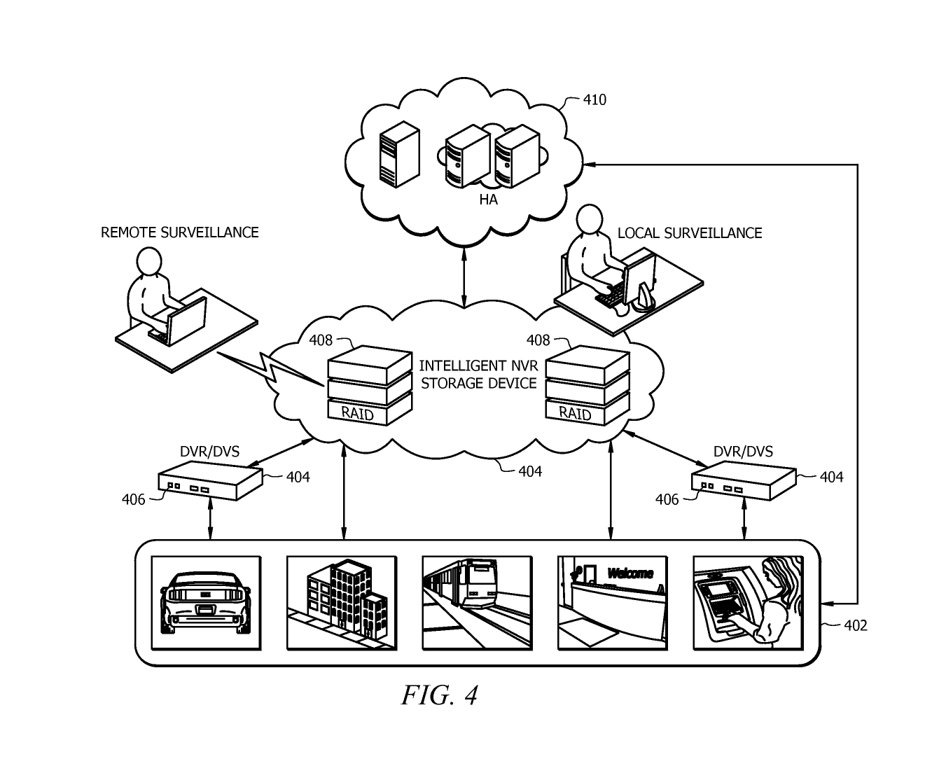

FIG. 4 depicts several possible pathway configurations for a tiered storage and policy management for video surveillance embodiment according to the present disclosure, e.g., method 300 of FIG. 3. FIG. 4 depicts images 402 captured from media capture devices, e.g., cameras 202 of FIG. 2, at a plurality of locations, e.g., at a business, in a parking lot, on a sidewalk, at a commuter rail, in a lobby, at an automatic teller machine (ATM), and at a parade via a smartphone. Some of the capture devices may optionally archive content in local memory. FIG. 4 also depicts storage locations 404, e.g., storage locations 204 of FIG. 2, which may include network DVR/DVS 406 and NVR storage devices 408, as well as cloud-based storage locations 410, which may comprise a plurality of cloud-based storage locations, each configured to receive archive video content from one another and/or one or more media capture devices. Thus, there are four primary pathways depicted for accomplishing a transfer of video surveillance content to a storage location, e.g., according to block 304 of FIG. 3: (1) camera to network device, (2) network device to cloud(s), (3) cloud to cloud, and (4) camera to cloud. By utilizing one or more of these pathways, the disclosed embodiments enable both local monitoring and/or storage, e.g., at an on-premises location with respect to the camera (for example, at the capturing device or on a LAN), and remote monitoring and/or storage, e.g., at an off-premises location with respect to the camera (for example, on a WAN and/or in the cloud), of the video feed as well as local and/or remote granular archiving of media based on a variety of predefined criteria.

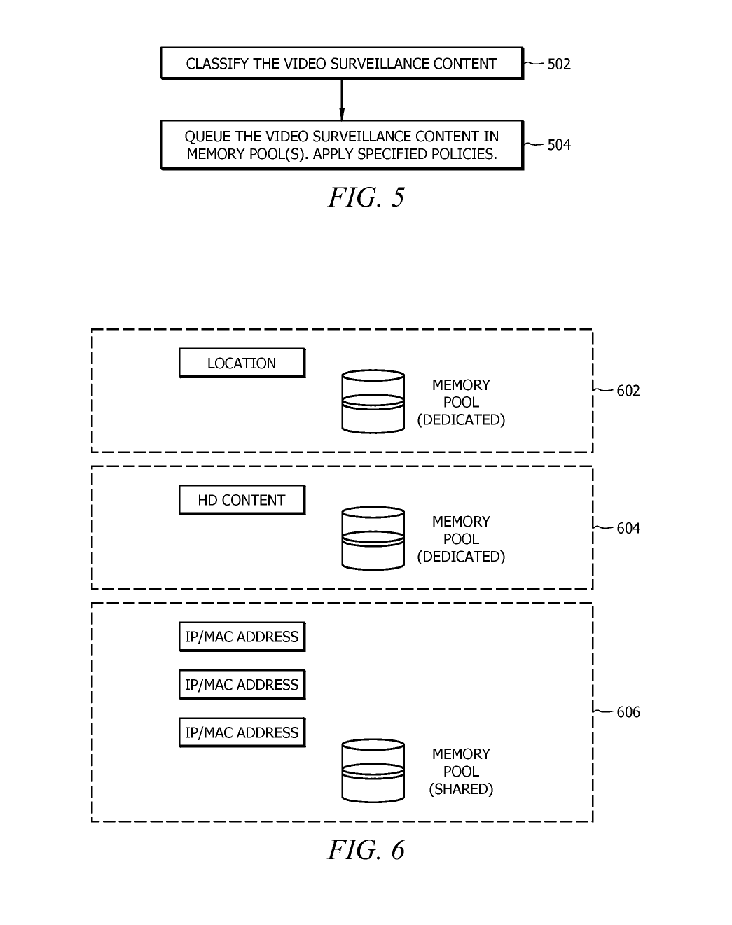

FIG. 5 is a flowchart describing an embodiment of a method 500 of tiered storage and policy management for video surveillance. At block 502, the storage location video management software may begin the two-stage video content management protocol of granular content archiving by classifying the video content. Block 502 may be accomplished at the capture device, e.g., at the capture devices of FIG. 4 and/or block 302 of FIG. 3, or at storage locations, e.g., at storage locations 404 of FIG. 4 and/or block 304 of FIG. 3. At block 502, the method 500 may assign the video content a particular classification. The assigned classification may be based on one or more optionally selected granular variables, e.g., the IP/Media Access Control (MAC) address of the endpoint, content type (e.g., standard definition, HD), confidentiality of the video, or location of the camera (e.g., in a secure environment or in an unsecure environment). For example, a local video surveillance camera may classify the content type as being HD. In another example, a smartphone mobile device configured to capture video content and having connectivity to a cloud may itself classify the content, e.g., using the geographic location of the mobile device. In still another example, a router, e.g., router 110 of FIG. 1, may classify the content type based on IP/MAC address. At block 504, the method 500 may begin the second stage of the video content management protocol by queuing video content in one or more memory pools at one or more storage locations, e.g., storage location 404 of FIG. 4, according to the relevant video content classification. As explained further below, method 500 may support traffic and congestion management at the queue and memory pool assignment level by providing thresholds, e.g., size thresholds, which may trigger certain priority rules or actions, e.g., assigning video content to a different memory pool, when the thresholds are approached, met, or exceeded. Method 500 management protocols may queue the video content in one or more dedicated and/or shared memory pools. Additionally, the video content management protocols may provide multi-tenant support, enabling service deployments for managed multi-tenant configurations. For example, the protocols may utilize partitioned memory storage to segregate multiple tenants while queuing video content having different sets of policies particular to each of the multiple tenants, e.g., carriers, mall operators, Video Surveillance as a Service (VSaaS) providers, etc. Block 504 may be accomplished at the capture device, e.g., at the capture devices of FIG. 4 and/or at block 302 of FIG. 3, at a router, e.g., router 110 of FIG. 1, or at storage locations, e.g., at storage locations 404 of FIG. 4 and/or at block 304 of FIG. 3. For example, a general purpose blade server residing in a router may be connected to a number of IP cameras. Traffic from the cameras may be routed and/or forwarded to the blade server equipped with a subset of NVR/DVR functionality, specifically recording server functionality. The blade server may permit viewing, live streaming, or content archiving.

To accomplish these or other protocols, a router, e.g., router 110 of FIG. 1, may monitor and measure the traffic load on a communications link, e.g., the second link 114 (the WAN link), in terms of load, which may be measured in terms of bandwidth and/or data rate. The measured traffic may comprise traffic sent from the storage location to the router, traffic sent from the router to the storage location, or both. The router may measure the load of different types, including different backup data traffic and other normal traffic (non-backup traffic). The router may distinguish between the backup data traffic and the normal traffic based on service identifications (IDs) (e.g., quality of service (QoS) IDs), application IDs, or both. Such service and application IDs may be used to distinguish traffic of different services and applications and may be embedded in the packets of the corresponding traffic. Alternately, the router may receive traffic load information directly from the storage location.

When the traffic load on communications link is determined to be light or low, a service card or appliance, which may be coupled to or part of the router, may be instructed by a policy element in the router to initiate or trigger the backup or synchronization service, and hence router may start to receive or send backup data on the communications link. The policy element may be a processor in the router configured to implement policy rules as discussed above. The monitored traffic load on the communications link may be determined to be light or low based on a determined policy or service level agreement (SLA). For instance, the traffic may be determined to be low if the normal traffic, i.e., the non-backup traffic, is below a determined threshold (e.g., in terms of bandwidth or data rate) according to policy or SLA. The threshold may be a determined value (bandwidth or data rate) or a percentage of the total bandwidth or data rate of the communications link, for example about 10 percent of the total link capacity. Alternatively, according to policy or SLA, the traffic may be determined to be low if the normal traffic on the communications link is idle.

If the traffic load on the communications link is not deemed to be low, the service card or appliance may be instructed by the policy element in the router to suspend or disable the backup or synchronization service. In another scenario, the service card or appliance may be instructed to suspend or disable the backup or synchronization service when the normal traffic load on the communications link is above a determined threshold or when the communications link is utilized more than a determined percentage, according to policy or SLA. The service card or appliance may be instructed to initiate the backup or synchronization service when the normal traffic load on the communications link is below a determined threshold or is idle on the communications link. To suspend the backup or synchronization service, the service card or appliance may be instructed to signal the appropriate backup data system, e.g., backup data system 120 of FIG. 1, to stop forwarding the backup traffic between the backup data system and the router. The backup or synchronization service may later be restarted where it left off without packet loss. Alternatively, the backup or synchronization service may be disabled by dropping the backup data packets at the router.

The backup or synchronization service may be suspended or disabled by the router based on measurement of the traffic on the communications link, as described above. The router may measure the ingress and/or egress bandwidth for the traffic on the communications link (e.g., the normal traffic) to determine prioritizing, suspending, or disabling the service, as described above. Thus, the backup or synchronization service may be suspended locally at the router between the communications link and a second communications link, e.g., link 114 of FIG. 1. In another embodiment, the backup or synchronization service may be suspended or disabled remotely, e.g., from the first communications link to the second communications link or vice versa.

Further, different types of backup traffic may be assigned different priority. As such, the router may initiate the different backup or synchronization services in the order of their assigned priority, where the backup or synchronization service with the highest priority may be initiated first followed by the backup or synchronization service with lower priority. For example, a file backup service may be assigned a first priority (highest), a database service may be assigned a second priority, and a video surveillance service may be assigned a third priority (lowest). Accordingly, the file backup service may be initiated first, followed by the database service, and then the video surveillance service. A higher priority service may be allowed to finish its backup or synchronization first before a lower priority service is initiated. This may avoid a situation of having multiple backup/synchronization services attempting to backup data at about the same time, which may cause undesired delays, losses, competition for resources, or combinations thereof. The router may also disable the different backup or synchronization services in the order of their assigned priority, e.g., starting first with the service that has lowest priority. For example, the video surveillance service that has lowest priority may be disabled first, followed by the database service, and then the file backup service.

FIG. 6 depicts three example managed video surveillance content memory pools. Captured surveillance video content may be classified and queued, e.g., using method 500 of FIG. 5, at a storage location, e.g., storage locations 404 of FIG. 4. Each queue may comprise a plurality of pointers to video surveillance content stored in one or more separate memory pools. Memory pools may be selected for use according to a variety of considerations, e.g., access speed, stability, physical storage location, facility bandwidth, etc. The first memory pool 602 is a dedicated memory pool having content classified according to the location of capture. For example, a variety of surveillance video content, e.g., standard definition and HD video content, may be stored in the same dedicated memory pool if recorded at the same location, e.g., at different perspectives in the lobby of a bank. The second memory pool 604 is a dedicated memory pool having surveillance video content classified as HD content. For example, the surveillance video content received from a variety of locations, e.g., three separate secure locations on different floors within a single business complex, may be received and stored in a dedicated memory pool where the video is classified as HD. The third memory pool 606 is a shared memory pool having surveillance video content received from a plurality of IP/MAC addresses. For example, memory pool 406 may permit storage of HD and standard definition surveillance video content from a plurality of geographically distinct restaurant franchise locations having a common owner in a single, shared memory pool.

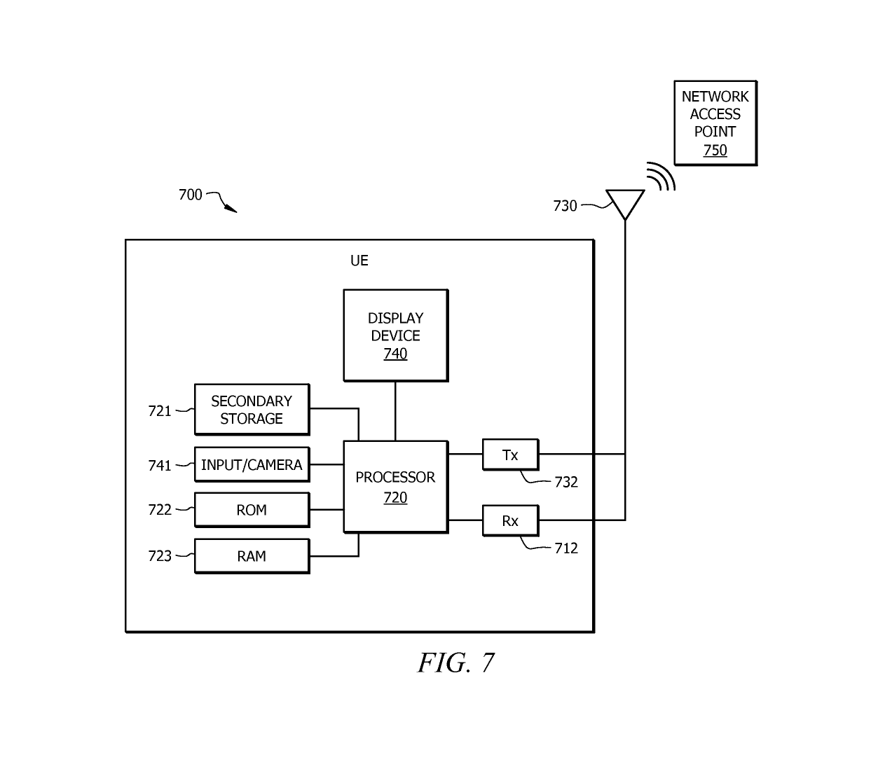

Video capture devices, such as those discussed herein, may operate in a telecommunications system and may be required to wirelessly transmit and receive multiple types of data substantially simultaneously. Video capture devices, e.g., mobile smartphones, may be equipped with a plurality of antennas that may operate as transmitters and/or receivers (or transceivers) to transmit and receive data. The video capture devices' antennas may wirelessly communicate with a network by transmitting and/or receiving data over specified frequencies. FIG. 7 is a schematic diagram of an embodiment of a video capture device 700, e.g., a mobile device containing a camera 202 of FIG. 2. Video capture device 700 may comprise a two-way wireless communication device having voice and data communication capabilities. In some aspects, voice communication capabilities are optional. The video capture device 700 generally has the capability to communicate with other computer systems on the Internet, e.g., via a link 112 of FIG. 1. Depending on the exact functionality provided, the video capture device 700 may be referred to as a data messaging device, a cellular telephone, a wireless Internet appliance, a wireless device, a smart phone, a mobile device, and/or a data communication device, as example.

Video capture device 700 may comprise a processor 720 (which may be referred to as a central processor unit or CPU) that is in communication with memory devices including secondary storage 721, read only memory (ROM) 722, and random access memory (RAM) 723. The processor 720 may be implemented as one or more CPU chips, one or more cores (e.g., a multi-core processor), or may be part of one or more application specific integrated circuits (ASICs) and/or digital signal processors (DSPs). The processor 720 may be configured to implement any of the schemes described herein, and may be implemented using hardware, software, firmware, or combinations thereof.

The secondary storage 721 may be comprised of one or more solid state drives, disk drives, and/or other memory types and is used for non-volatile storage of data and as an over-flow data storage device if RAM 723 is not large enough to hold all working data. Secondary storage 721 may be used to store programs that are loaded into RAM 723 when such programs are selected for execution. The ROM 722 may be used to store instructions and perhaps data that are read during program execution. ROM 722 may be a non-volatile memory device may have a small memory capacity relative to the larger memory capacity of secondary storage 721. The RAM 723 may be used to store volatile data and perhaps to store instructions. Access to both ROM 722 and RAM 723 may be faster than to secondary storage 721.

The video capture device 700 may communicate data (e.g., packets) wirelessly with a network via a network access point 750. As such, the video capture device 700 may comprise a receiver (Rx) 712, which may be configured for receiving data (e.g. wireless packets or frames) from other components. The receiver 712 may be coupled to the processor 720, which may be configured to process the data and determine to which components the data is to be sent. The video capture device 700 may also comprise a transmitter (Tx) 732 coupled to the processor 720 and configured for transmitting data to other components, for example by using protocols such as IEEE 802.11, IEEE 802.16, 3rd Generation Partnership Project (3GPP), Global System for Mobile Communications (GSM), or similar wireless protocols. The receiver 712 and transmitter 732 may be coupled to a plurality of antennas 730, which may be configured to receive and transmit wireless radio frequency (RF) signals. In some embodiments, Tx 732 and Rx 712 may be replaced by a transceiver comprising the functionality of both Tx 732 and Rx 712.

The video capture device 700 may also comprise a display 740 coupled to the processor 720, that displays output thereof to a user. In some embodiments, display 740 is a display station remote from the video capture device 700. The video capture device 700 and the display 740 may configured to display representations of data to a user. The device display 720 may comprise a Color Super Twisted Nematic (CSTN) display, a thin film transistor (TFT) display, a thin film diode (TFD) display, an organic light-emitting diode (OLED) display, an active-matrix OLED display, or any other display screen. The display 740 may display in color or monochrome and may be equipped with a touch sensor based on resistive and/or capacitive technologies. In some embodiments, the device display

The video capture device 700 may further comprise an input device 741 coupled to the processor 720, which may allow the user to input commands to the video capture device 700. In the case that the display device 740 comprises a touch sensor, the display device 740 may also be considered the input device 741. In addition to and/or in the alternative, an input device 741 may comprise a mouse, trackball, built-in keyboard, external keyboard, and/or any other device that a user may employ to interact with the video capture device 700. In the context of media capture, e.g., surveillance video capture, input device 741 may be a camera.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term about means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. All documents described herein are incorporated herein by reference.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
a processor configured to:
receive captured video; and p1 perform a two-stage video content management protocol, wherein the first stage comprises classifying the video content according to one or more granular variables, and wherein the second stage comprises queuing classified video in a storage memory.

2. The apparatus of claim 1, wherein the processor is not located in the same device as the video capture device.

3. The apparatus of claim 2, wherein the processor is further configured to receive a plurality of captured videos from a plurality of video capture devices.

4. The apparatus of claim 1, wherein the processor is local with respect to the video capture device, and wherein the processor is further configured to transmit captured video to a remote storage location.

5. The apparatus of claim 4, wherein the remote storage location is selected from a plurality of remote storage locations based on the classification of the captured video.

6. The apparatus of claim 1, wherein the one or more granular variables are selected from a group consisting of: Internet Protocol (IP)/Media Access Control (MAC) address of the originating source, content type, and location of the video capture device.

7. The apparatus of claim 1, wherein the apparatus is a mobile communication device and the captured video is received via a camera integral to the mobile communication device.

8. A computer program product comprising computer executable instructions stored on a non-transitory medium that when executed by a processor cause the processor to perform the following:
monitor a performance metric associated with each of a plurality of storage locations, wherein each storage location has at least one memory pool;
receive a video, wherein the video is classified according to at least one predefined criteria;
utilize the video classification and the performance metrics to determine a destination storage location memory pool; and
send the video to the destination storage location memory pool for storage.

9. The computer program product of claim 8, wherein the performance metric is selected from a group consisting of: load, bandwidth, available memory pool size, and availability.

10. The computer program product of claim 9, wherein the instructions further cause the processor to utilize the size of the video to determine a destination storage location memory pool.

11. The computer program product of claim 8, wherein the instructions further cause the processor to prioritize the sending of the video in comparison to other traffic, and wherein the non-transitory medium is comprised within a device selected from a group consisting of: a router, a switch, and an access point.

12. The computer program product of claim 8, wherein the instructions further cause the processor to execute a policy prior to sending.

13. The computer program product of claim 12, wherein the policy is selected from a group consisting of: content encryption, content compression, format conversion, and transmission availability/reliability verification.

14. The computer program product of claim 8, wherein the predefined criteria is selected from a group consisting of: Internet Protocol (IP)/Media Access Control (MAC) address of the originating source, content type, and location of the video capture device

15. In a network node of a network system comprising a plurality of nodes, a method of managing video storage, comprising:
receiving a video from a video source;
identifying the classification of the video content;
monitoring a plurality of network performance parameters;
selecting a destination network memory pool based on the classification of the video content and the results of the network performance parameter monitoring;
transmitting the video to the destination network memory pool;
obtaining the storage location of the video in the network memory pool;
assigning a pointer to the storage location of the video; and
adding the pointer to a pointer queue.

16. The method of claim 15, wherein the classification is selected from a group consisting of: Internet Protocol (IP)/Media Access Control (MAC) address of the originating source, content type, content confidentiality, and location of the video capture device.

17. The method of claim 15, wherein the memory pool is selected from a group consisting of: a shared memory pool and a dedicated memory pool.

18. The method of claim 15, wherein the memory pool is selected from a group consisting of: a public memory pool, a private memory pool, and a hybrid public/private memory pool.

19. The method of claim 15, wherein the memory pool is selected from a plurality of memory pools based on the classification of the captured video, and wherein the pointer queues are managed on a memory pool basis.

20. The method of claim 15, wherein the captured video is stored in a plurality of memory pools.
